(19) United States
(12) Patent Application Publication
(10) Pub. No.: US 2018/0010723 A1
(43) Pub. Date: Jan. 11, 2018

(54) High Voltage Skin Effect Trace Heating Cable Isolating Radial Spacers

(71) Applicant: Pentair Thernal Management LLC, Redwood City, CA (US)

(72) Inventors: Wesley Dong, Belmont, CA (US); Paul Becker, San Carlos, CA (US)

(21) Appl. No.: 15/596,969

(22) Filed: May 16, 2017

Related U.S. Application Data
(60) Provisional application No. 62/337,151, filed on May 16, 2016.

(51) Int. Cl. F16L 53/00

(52) U.S. Cl. CPC F16L 53/008

(57) ABSTRACT

A skin effect heating system for long pipelines includes a heater cable disposed in a ferromagnetic or other conductive heat tube, the heater cable and heat tube cooperating to produce heat that is applied to the carrier pipe. The heater cable includes a conductor surrounded by an insulating layer that includes a generally tubular core insulation and a plurality of structural spacers extending from the core insulation. The spacers dispose the conductor closer to the center of the heat tube, and space the core insulation away from the heat tube in order to minimize or eliminate partial discharge at voltages in excess of 5 kV. The spacers may be axial or lateral “ribs” that contact the inner surface of the heat tube and create an air gap between the heat tube and the core insulation, the air gap significantly reducing charge buildup on the outer surface of the core insulation.

### CROSS-REFERENCE TO RELATED APPLICATIONS

This application claims the benefit of priority from U.S. Prov. Pat. App. Ser. No. 62/337,151, filed under the same title on May 16, 2016, and incorporated fully herein by reference.

### BACKGROUND OF THE INVENTION

The field of the invention is high voltage heater cables. More particularly, the invention relates to wire designs for skin effect heat tracing system components.

In the oil and gas industry, pipelines must be heated over distances of many miles. Skin effect electric heat tracing systems are ideally suited for long transfer pipelines up to 12 miles (20 km) per circuit. The system is engineered for the specific application. Applications for this system include material transfer lines, snow melting and de-icing, tank foundation heating, subsea transfer lines and prefabricated, pre-insulated lines. In a skin-effect heating system, a heater cable having an electrically insulated, temperature-resistant conductor is installed inside a ferromagnetic heat tube; the heat tube is thermally coupled to the pipe to be heat traced (i.e., at the outer surfaces of the carrier pipe and heat tube), and the conductor of the heater cable is connected to the heat tube at the far end while the near ends of the conductor and heat tube are connected to an alternating current (AC) power supply; AC is passed through the insulated conductor and returns through the heat tube. Heat is generated by both the heat tube and the heater cable, and the heat is transferred to the carrier pipe. In addition, due to the skin effect the return current carried by the heat tube (running directionally opposite to the electric current carried by the heater cable's conductor) concentrates within a “skin depth” from the inner surface of the heat tube, with the charge density being greatest at the inner surface.

The ferromagnetic heat tube of a skin-effect heating system is prone at voltages above about 5 kV to the corona effect: a charge difference builds up between the inner surface of the heat tube and the outer surface of the insulation layer surrounding the conductor until it exceeds the breakdown electric field for air (about 3×10⁶ V/m), causing a localized discharge resulting from transient gaseous ionization. This effect becomes a significant issue for longer pipelines that require a higher voltage potential to drive the current that also results in greater charge build up between the two surfaces. The accumulated static electricity can damage or prematurely age the insulation and other components, and can discharge in arcing events.

In a traditional skin effect heating system, the electrical insulation layer surrounding the core conductor is the outer layer of the heater cable; thus, the outer surface of the insulation layer contacts the inner surface of the heat tube. The heater cable is surrounded by air except at the point at which the insulating layer lies in contact with the inner surface of the heat tube. Partial discharge occurs approximate the contact area due to the charge differential between the surface of the insulation and the inner surface of the grounded heat tube. Protracted partial discharge can erode solid insulation and eventually lead to breakdown of insulation at the point of contact. Protracted partial discharge also tends to initiate defects (voids, imperfections, contaminants) in the heat tube.

It is desirable to heat pipelines on the order of 36 miles and to handle voltages larger than 5 kV and up to 10 kV or higher. Thus it would be desirable to use a device to reduce or eliminate the risk of partial discharge.

### SUMMARY OF THE INVENTION

The present disclosure describes skin effect heating systems that overcome the aforementioned drawbacks by providing a heater cable to be placed inside a heat tube. The heater cable comprises a core conductor and an electrical insulation layer surrounding the core conductor. The electrical insulation layer has a first thickness at some areas and a second thickness at other areas, the first thickness being greater than the second thickness. Thus, the first insulation thickness creates an air gap between the second insulation thickness and the heat tube, the air gap reducing or preventing partial discharge when a continuous applied voltage is greater than 5 kV.

The present disclosure also provides a method to increase the distance between an insulation layer and a ground plane of a heater cable inside a heat tube. The steps of the method include determining an ideal insulation thickness for use with the particular heat tube and heater cable using predictions of electric field inside the heat tube based on computer models, extruding a core insulation from an insulation material; and placing “spokes” (or “ribs”), made from an insulation material, around the cable.

In one aspect, the present disclosure provides a skin effect heating system including a ferromagnetic heat tube that couples to a carrier pipe to deliver heat to the carrier pipe, and a heater cable disposed in the heat tube. The heater cable includes a core conductor electrically connecting to a supply of alternating current and to the heat tube such that the alternating current flows in opposite directions through the core conductor and the heat tube, the alternating current in the heat tube being concentrated at an inner surface of the heat tube due to skin effect. The heater cable includes an electrically insulating layer having a core insulation surrounding the core conductor and having a thickness, and a plurality of structural spacers extending from the core insulation, one or more of the structural spacers contacting the inner surface of the heat tube and spacing the core conductor a first distance from the inner surface of the heat tube, the first distance being greater than the thickness of the core insulation.

The alternating current can be applied at a voltage greater than 5 kV, and the first distance can space the core insulation from the inner surface of the heat tube such that partial discharge at an outer surface of the core insulation is eliminated. The structural spacer(s) contacting the inner surface of the heat tube can produce an air gap between the core insulation and the heat tube, the air gap reducing or preventing partial discharge of the core insulation when the alternating current is applied at a voltage greater than 5 kV. The plurality of structural spacers can be uniformly spaced and uniformly sized and can extend axially along an entire length of the heater cable. The plurality of structural spacers can be substantially parallel to an axis of the heater cable.

The system can further include a cable gland for transitioning the heater cable from the heat tube to a second heat tube disposed at an angle to the first heat tube. The cable gland can have: a ferromagnetic base member to which the heat tube is welded at a first location and the second heat tube is welded at a second location; a first electrically insulating insert disposed in the base member and including a first channel extending from the first location to the second location; a second electrically insulating insert disposed in the base member over the first insert and having a second channel that cooperates with the first channel to form a pathway through which the heater cable is drawn from the first location to the second location and into the second heat tube; and, a cover attaching to the base member over the second insert and securing the first and second inserts within the base member.

In another aspect, the present disclosure provides a heater cable for a skin effect heating system. The heater cable includes a core conductor having a first end that connects to a supply of alternating current applied to the core conductor at a voltage exceeding 5 kV, and a second end that connects to a ferromagnetic heat tube that couples to a carrier pipe to deliver heat to the carrier pipe, wherein the alternating current flows in a first direction through the core conductor and in a second direction in the heat tube, the first direction opposite the second direction, the heater cable disposed in the heat tube such that the alternating current is concentrated at an inner surface of the heat tube due to skin effect. The heater cable also includes an electrically insulating layer surrounding the core conductor and spacing the core conductor from the inner surface of the heat tube, at least a first portion of the insulating layer contacting the inner surface of the heat tube and spacing a second portion of the insulating layer from the inner surface of the heat tube.

The first portion of the insulating layer can have a first thickness and the second portion of the insulating layer can have both a second thickness that is less than the first thickness, and an outer surface that does not contact the inner surface of the heat tube. The first thickness can be any value larger than the second thickness and equal to or less than a diameter of the heat tube measured at the inner surface. The insulating layer can have a plurality of structural spacers including the first portion and a third portion, the second portion being adjacent to and between the first and third portions, the first portion and the third portion contacting the inner surface of the heat tube and producing an air gap between the second portion and the inner surface of the heat tube.

The plurality of structural spacers can be parallel to each other, can be uniformly spaced radially around an axis of the heater cable, and can extend axially along at least part of the heater cable. The plurality of structural spacers can be parallel to the axis of the heater cable, or the plurality of structural spacers can twist around the axis of the heater cable in a spiral configuration. The plurality of structural spacers can each have curved surfaces that cooperate to provide the structural spacer with an impeller cross-sectional shape.

The plurality of structural spacers can each extend around a circumference of the heater cable and are uniformly spaced axially along at least part of the heater cable. The plurality of structural spacers can have a height that causes partial discharge between the heat tube and the heater cable to be concentrated at points of contact between the plurality of structural spacers and the inner surface of the heat tube.

In another aspect, the present disclosure provides a method of producing a skin effect heating system The method includes: determining, based on at least a heat tube to be coupled to a carrier pipe to deliver heat to the carrier pipe via skin effect heating, a first thickness and a second thickness for an insulation material; and, forming an electrically insulating layer over a core conductor to produce the heater cable, the insulating layer having a core insulation having the first thickness and a plurality of structural spacers extending from the core insulation and having the second thickness, such that one or more of the plurality of structural spacers contacts an inner surface of the heat tube and spaces the core insulation away from the inner surface of the heat tube a distance that substantially eliminates partial discharge at an outer surface of the core insulation when alternating current is applied to the core conductor at a voltage exceeding 5 kV. Forming the electrically insulating layer can include extruding the core insulation and the plurality of structural spacers together over the core conductor. Forming the electrically insulating layer can include forming the plurality of structural spacers as parallel ribs having uniform size and shape, uniformly spaced radially around the core insulation, and extending an entire length of the heater cable. Forming the electrically insulating layer can include forming the core insulation from a first insulating material and forming the plurality of structural spacers onto part of an outer surface of the core insulation, the plurality of structural spacers being made of at least a second insulating material different from the first insulating material.

The foregoing and other aspects and advantages of the disclosure will appear from the following description. In the description, reference is made to the accompanying drawings which form a part hereof, and in which there is shown by way of illustration a preferred embodiment in accordance with the disclosure. Such embodiment does not necessarily represent the full scope of the invention, however, and reference is made therefore to the claims and herein for interpreting the scope of the invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The following drawings are provided:

FIG. 1A is a perspective view of a heater cable with insulation in accordance with one embodiment of the invention.

FIG. 1B is a cross-sectional diagram of a heater cable with insulation inside a heat tube, in accordance with various embodiments of the present disclosure;

FIG. 2A is a contour plot of electric field strength in a cross section of a typical embodiment of a prior art heater cable as it sits inside a heat tube.

FIG. 2B is a contour plot of electric field strength in a cross section of a heater cable according to one embodiment of the present disclosure as it sits inside a heat tube.

FIG. 3A is a perspective view of an embodiment of the present disclosure featuring radial spacers.

FIG. 3B is a perspective view of a similar embodiment of the present disclosure featuring split loom tubing.

FIG. 4A is a perspective view of another embodiment of the invention featuring an “impeller” shape.

FIG. 4B is a perspective view of another embodiment of the present disclosure featuring an “impeller” shape with structural spacers composed of multiple materials.

FIG. 4C is a perspective view of another embodiment of the present disclosure featuring spacers that are a hybrid of multiple shapes.

FIG. 5A is a perspective view of another embodiment of the present disclosure featuring a helical pattern.

FIG. 5B is a perspective view of another similar embodiment of the present disclosure featuring helically slit tubing.

FIG. 6 is a perspective view of a ferromagnetic 90-degree elbow with insulating inserts that may be used with some embodiments of the present invention.

### DETAILED DESCRIPTION OF THE INVENTION

Skin effect trace heating systems presently operate at nearly 5 kV. The present disclosure provides a skin effect trace heating system that can operate at over 5 kV, such as at 7.5 kV, 10 kV, or higher. A heater cable and heat tube as described herein, carrying electric current at voltages over 5 kV, can have a longer length between power connections than presently known systems that operate at 5 kV. In particular, embodiments of the present disclosure provide heater cable profiles, structures, and compositions that enable heater cable lengths of 36 miles or more between power connections.

In typical installations, the heater cable rests in contact with the inner surface of the heat tube, typically at the bottom of the heat tube. This eccentric geometry produces non-uniform electrical fields with the highest electric field being where the heater cable contacts the heat tube, as this location is where both: the respective materials of the heater cable and heat tube can interact with each other; and, the conductor of the heater cable is closest to the inner surface of the heat tube, which carries the return current due to skin effect as described above. To maximize uniformity of the electric fields, the optimal positioning for the conductor is to be radially centered with respect to the grounded heat tube.

While it may be possible to achieve larger distances between the conductor and the ground plane, and to bring the conductor closer to center within the heat tube, by simply increasing the heater cable's insulation thickness, doing so introduces a number of issues: increased weight and cost of the heater cable, greatly reduced flexibility and increased bend radii required to pull the heater cable through the heat tube, and greater likelihood of the heater cable getting stuck in the heat tube during installation.

In order to ensure a more uniform electric field to minimize corona effects, heater cables of the present disclosure include features that space the heater cable's conductor away from the local ground plane (i.e., the inner surface of the heat tube). One such embodiment includes an insulation layer extruded over the conductor with rib-like structural spacers that effectively increase the distance to the ground plane. This maintains flexibility while increasing the air gap to the heat tube and making electric fields more uniform and less stressful on the insulation. The ribs in the extrusion can be radially or laterally spaced. In one embodiment, the core insulation and the ribs may be coextruded from the same piece of insulation material. In another embodiment, the core insulation and the ribs are extruded separately from the same or different insulation materials, and the ribs are installed over the core insulation in a factory, for example by extruding the ribs over the core insulation. In yet another embodiment, the ribs may be a separate component to be installed over the core insulation in the field. The radial height of the ribs, relative to the core insulation, may be any nonzero value larger than the core thickness and equal or less than the inner diameter of the heat tube.

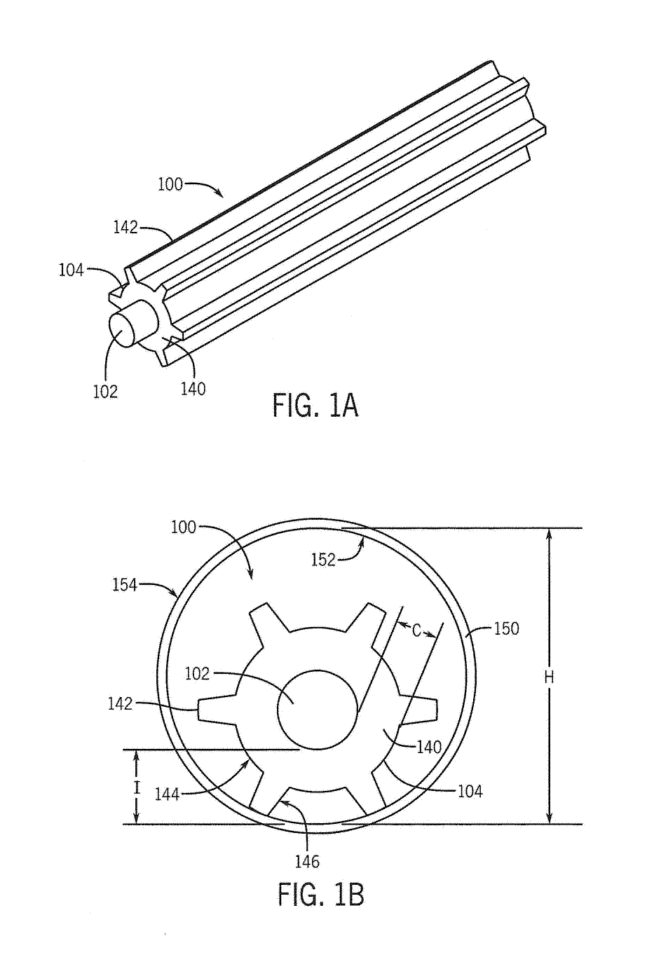

Turning now to FIG. 1A, an example embodiments of a heater cable 100 for a skin effect heating system can include a core conductor 102 and an electrically insulating layer 104 surrounding the conductor 102. The insulating layer 104 can have a first portion, referred to herein as “core insulation” 140 that contacts the core conductor 102 and has a substantially uniform tubular profile with an outer surface 144. The insulating layer 104 can further have a second portion comprised of one or more spacing structures, such as “ribs” 142, that extend from the core insulation 140 and run along the heater cable 100 in one or more directions. In the example of FIG. 1A, the ribs 142 extend along the length of the heater cable 100 parallel or substantially parallel to the axis of the heater cable 100. The ribs 142 may be uniformly or variably spaced and/or uniformly or variably sized. In the illustrated embodiment, six ribs 142 or “spokes” are shown. Other numbers of spokes, from 3 or more, are also feasible. In various embodiments, 5-8 spokes may be used to separate the core conductor 103 from the ground plane as described herein, and to also maintain good flexibility of the heater cable 100.

FIG. 1B demonstrates that the heater cable 100, disposed in a heat tube 150, can produce a distance I from the core conductor 103 to a ground plane formed by the inner surface 152 of the heat tube 150. In some embodiments, the core insulation 140 may be a thickness that is within a common range for skin effect heater cable insulation layers, and the thickness of the insulating layer 104 will be even greater at the points where the ribs 142 are located. For example, the insulation thickness without ribs 142 (i.e., the core insulation 140 thickness) can be 3.6 mm, while the insulation thickness with ribs 142 can be 6.42 mm; thus, the conductor 102 can be disposed about 2.50 mm-2.82 mm closer to the center of the heat tube 150, depending on the spacing on the ribs 142. As shown, one or more, and preferably two or more, of the ribs 142 are the parts of the insulation layer 104 that contact the inner surface 152 of the heat tube 150 (e.g., a 25.4 mm diameter heat tube) when the heater cable 100 is in its stable position. In some embodiments, when the heater cable 100 sits in its stable position in the heat tube 150, an air gap 160 may be formed between the inner surface 152 of the heat tube 150, the outer surfaces 146 of adjacent ribs 142 that contact the heat tube 150, and the outer surface 144 of the core insulation 140 that lies between the adjacent ribs 142. This air gap 160 isolates the outer surface 144 of the core insulation 140 from the inner surface 152 of the heat tube 150, further preventing partial discharge as other insulating surfaces of the heater cable 100 are closer to the ground plane and are more likely to accumulate electric charge.

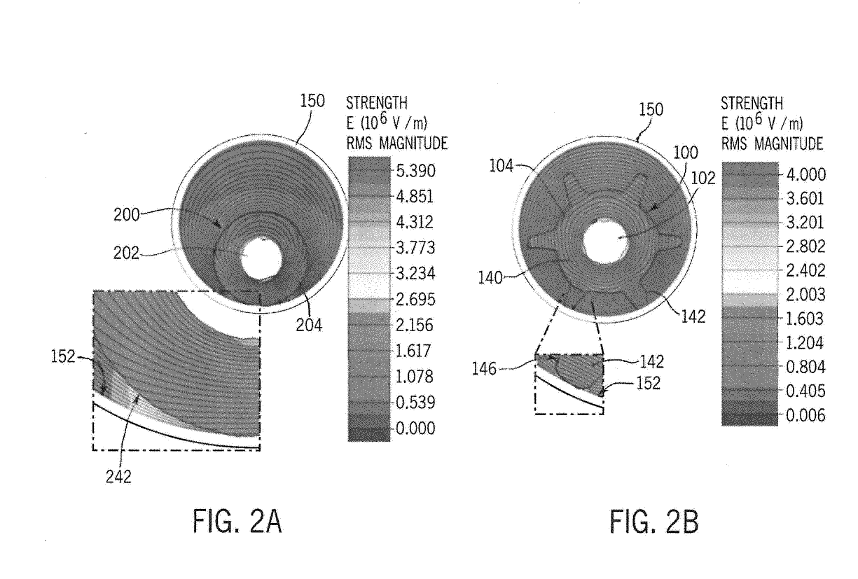

FIGS. 2A-B illustrate the improved distribution in electric fields in the heat tube 150, In FIG. 2A, the electric field in a cross section of a standard heater cable 200 geometry, including a core conductor 202 and an insulating layer 204, is mapped. The area where partial discharge could occur (electric field over MV/m) is significant and occurs directly on the surface 242 of the primary insulation approximate the point of contact between the insulating layer 204 and the inner surface 152 of the heat tube 150. In contrast, FIG. 2B shows that with the cross-sectional geometry of the heater cable 100 of FIGS. 1A-B, partial discharge only occurs on two relatively small areas of the outer surface 146 of the ribs 142 that contact the inner surface 152 of the heat tube 150; partial discharge does not occur on the surface of the core insulation 140. Further, there is an area at the conductor 202 to insulating layer 204 inner surface interface, nearest the ground plane, where partial discharge might occur for the standard heater cable 200; this area does not appear in the present heater cable 100 due at least partially to the increased distance of the conductor 102 from the ground plane (i.e., inner surface 152 of the heat tube 150).

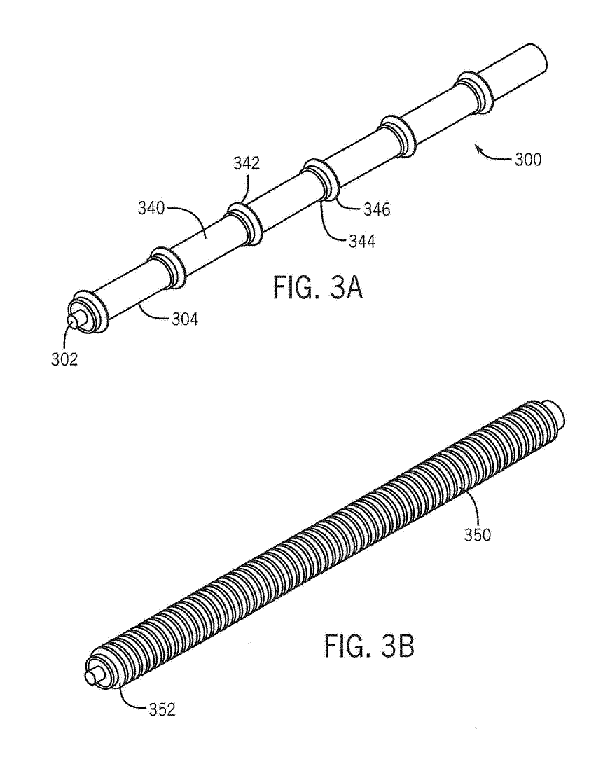

The structural spacers of the heater cable can have different sizes, shapes, and number in various embodiments. FIG. 3A illustrates another example heater cable 300 with a core conductor 302 and an electrically insulating layer 304 as described above. Instead of radially spaced, axially extending ribs, the heater cable 300 includes annular spacers 342 extending from the core insulation 340 in a flange configuration, and spaced axially along the external surface of the core insulation 340. The annular spacers 342 may have a curved portion 344 that extends to meet a planar portion to form the trumpet shape. The spacers 342 may have any suitable spacing that creates a charge-distributing air gap between the core insulation 340 and the ground plane as described above; FIG. 3B illustrates another example where the annular spacers 342 are approximate each other, giving the appearance of a corrugated surface.

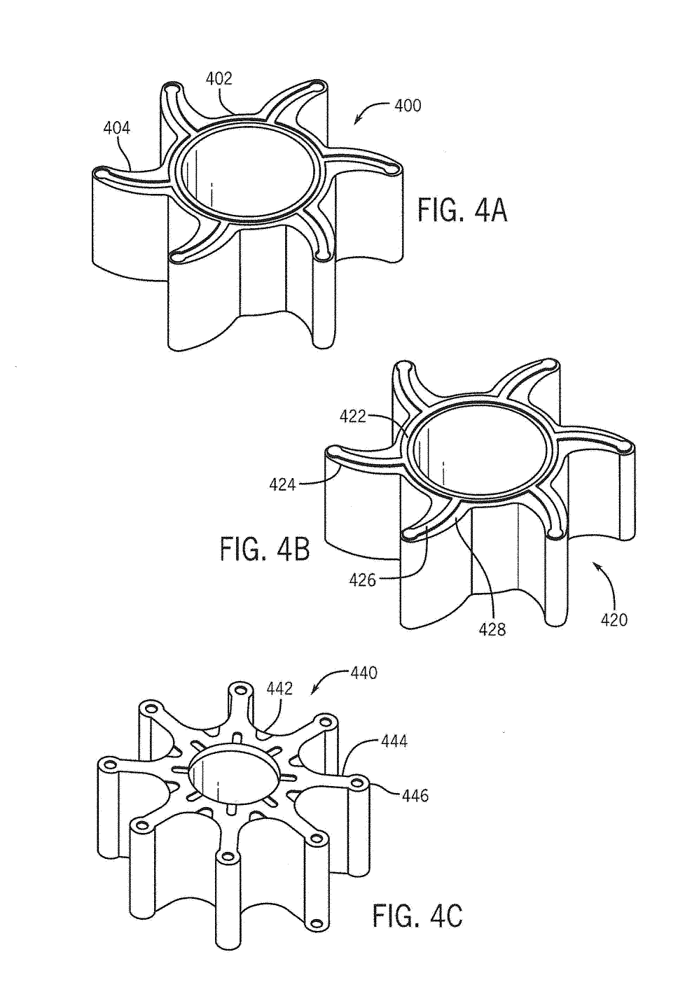

Other cross-sectional shapes of radially spaced ribs such as the ribs 142 of FIG. 1 (which are generally trapezoidal in cross-sectional shape) may be used. FIG. 4A shows a profile of an example insulation layer 400 in which radially spaced ribs 404 extending from a core insulation 402 have curved leading and trailing faces that together form an “impeller” cross-sectional shape. Additionally, the structural spacers may be composed of multiple materials. FIG. 4B shows another example insulating layer 420 profile in which the structural spacers 424 extending from the core insulation 422 include an internal member 426 that is the same material as the core insulation 422 (and, in some embodiments, may be extruded together with the core insulation 422. The spacers 424 further include a second insulating material 428, which may be a coating, a co-extrusion, etc., and which forms the outer surface of at least the structural spacers 424. In the illustrated example, the second insulating material 428 provides the “impeller” shape of the spacers 424 as in FIG. 4A. FIG. 4C illustrates another example insulating layer 440 profile in which the spacers are a hybrid of multiple shapes: a rectangular base member 444 extends from the core insulation 442 and a circular end portion 446 is attached at the end of the base member 444.

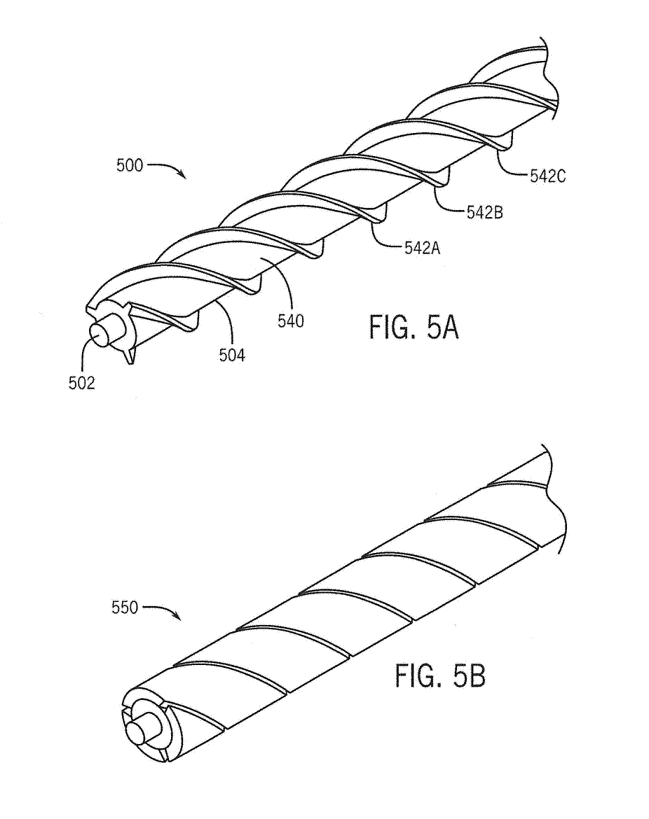

The structural spacers may also have a combination of lateral and radial positioning, in some embodiments being formed in a spiral or similar configuration. FIG. 5A illustrates an example heater cable 500 with a core conductor 502 and an insulating layer 504 having a core insulation 540 and structural spacers 542A, 542B, 542C as described above. In this embodiment, the structural spacers 542A-C may be spaced apart from each other a uniform distance, and may twist around the length of the heater cable 500 (e.g., as achieved by a helical extrusion). In another embodiment, rather than adding the structural spacers to the core insulation, as described above, to achieve the additional spacing the manufacture of a heater cable may begin with a tubular insulating layer that is the maximum thickness (i.e., the width measured from the inner surface of the insulating layer to the tip of the structural spacer). The spacers may then be formed by removing material from the insulating layer. Alternatively, the insulating layer may be extruded helically through a notched die to produce recesses in the outer surface. FIG. 5B illustrates an exemplary cable 550 where the insulating layer 552 includes a helical slot 554. These are some of many possible geometries that could achieve the results described by this invention.

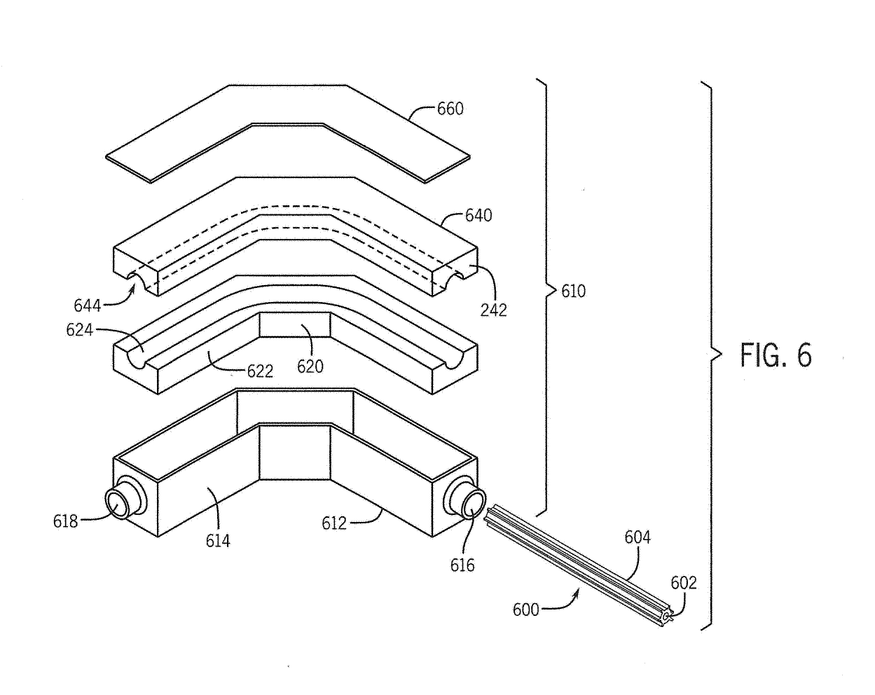

In some installations, the heater cable of the present invention may have to bend around an angle. To avoid flattening or otherwise impinging the structural spacers, thus bringing the core conductor closer to the heat tube, it may be necessary to use some sort of insulating parts on the inside radius of the bend, to ensure adequate distance to the ground plane. FIG. 6 illustrates a concept for transitioning a heater cable 600 from one heat tube 616 to another heat tube 618 that is perpendicular to the first heat tube 616, using a ferromagnetic 90-degree elbow cable gland with insulating inserts. Heat tubes 616, 618 are welded onto the ferromagnetic body 614 of a base member 612. The base member 612 continues to transmit the thermal energy produced in the skin effect heating system to the couple carrier pipe(s). Inserts 620, 640, made of an electrically insulating material, are placed inside the body 614. The bottom insert 620 has a channel 624 disposed in the insert body 622, and the top insert 640 has a cooperating channel 644 disposed in the insert body 642. A cover 660, which may also be ferromagnetic, is affixed with screws (not shown). After installation, jet line is blown in, and the heater cable 600 (with core conductor 602 and ribbed insulating layer 604 as described above) is pulled thru the elbow by inserting the heater cable 600 through the first heat tube 616 into the pathway formed by the cooperating channels 624, 644. The heater cable 600 follows the pathway out into the second heat tube 618. An alternate method of installation would be to use the elbow as an actual pull box, such that the heater cable 600 is pulled into one leg of the uncovered elbow, routed into the other leg, and pulled thru. Thus there would be no need to pull around a 90 degree bend at all. Rather, the pull would be through two straight lengths of tube.

The present invention has been described in terms of one or more preferred embodiments, and it should be appreciated that many equivalents, alternatives, variations, and modifications, aside from those expressly stated, are possible and within the scope of the invention.

What is claimed is:

1. A skin effect heating system comprising:
a ferromagnetic heat tube that couples to a carrier pipe to deliver heat to the carrier pipe; and
a heater cable disposed in the heat tube, the heater cable comprising:
a core conductor electrically connecting to a supply of alternating current and to the heat tube such that the alternating current flows in opposite directions through the core conductor and the heat tube, the alternating current in the heat tube being concentrated at an inner surface of the heat tube due to skin effect; and
an electrically insulating layer comprising:
a core insulation surrounding the core conductor and having a thickness; and
a plurality of structural spacers extending from the core insulation, one or more of the structural spacers contacting the inner surface of the heat tube and spacing the core conductor a first distance from the inner surface of the heat tube, the first distance being greater than the thickness of the core insulation.

2. The skin effect heating system of claim 1, wherein the alternating current is applied at a voltage greater than 5 kV, and the first distance spaces the core insulation from the inner surface of the heat tube such that partial discharge at an outer surface of the core insulation is eliminated.

3. The skin effect heating system of claim 1, wherein the one or more of the structural spacers contacting the inner surface of the heat tube produce an air gap between the core insulation and the heat tube, the air gap reducing or preventing partial discharge of the core insulation when the alternating current is applied at a voltage greater than 5 kV.

4. The skin effect heating system of claim 1, wherein the plurality of structural spacers are uniformly spaced and uniformly sized and extend axially along an entire length of the heater cable.

5. The skin effect heating system of claim 4, wherein the plurality of structural spacers are substantially parallel to an axis of the heater cable.

6. The skin effect heating system of claim 1, further comprising a cable gland for transitioning the heater cable from the heat tube to a second heat tube disposed at an angle to the first heat tube, the cable gland comprising:
a ferromagnetic base member to which the heat tube is welded at a first location and the second heat tube is welded at a second location;
a first electrically insulating insert disposed in the base member and including a first channel extending from the first location to the second location;
a second electrically insulating insert disposed in the base member over the first insert and having a second channel that cooperates with the first channel to form a pathway through which the heater cable is drawn from the first location to the second location and into the second heat tube; and
a cover attaching to the base member over the second insert and securing the first and second inserts within the base member.

7. A heater cable for a skin effect heating system, the heater cable comprising:
a core conductor having a first end that connects to a supply of alternating current applied to the core conductor at a voltage exceeding 5 kV, and a second end that connects to a ferromagnetic heat tube that couples to a carrier pipe to deliver heat to the carrier pipe, wherein the alternating current flows in a first direction through the core conductor and in a second direction in the heat tube, the first direction opposite the second direction, the heater cable disposed in the heat tube such that the alternating current is concentrated at an inner surface of the heat tube due to skin effect; and
an electrically insulating layer surrounding the core conductor and spacing the core conductor from the inner surface of the heat tube, at least a first portion of the insulating layer contacting the inner surface of the heat tube and spacing a second portion of the insulating layer from the inner surface of the heat tube.

8. The heater cable of claim 7, wherein the first portion of the insulating layer has a first thickness and the second portion of the insulating layer has:
a second thickness that is less than the first thickness; and
an outer surface that does not contact the inner surface of the heat tube.

9. The heater cable of claim 8, wherein the first thickness is larger than the second thickness and equal to or less than a diameter of the heat tube measured at the inner surface.

10. The heater cable of claim 7, wherein the insulating layer comprises a plurality of structural spacers including the first portion and a third portion, the second portion being adjacent to and between the first and third portions, the first portion and the third portion contacting the inner surface of the heat tube and producing an air gap between the second portion and the inner surface of the heat tube.

11. The heater cable of claim 10, wherein the plurality of structural spacers are parallel to each other, are uniformly spaced radially around an axis of the heater cable, and extend axially along at least part of the heater cable.

12. The heater cable of claim 11, wherein the plurality of structural spacers are parallel to the axis of the heater cable.

13. The heater cable of claim 11, wherein the plurality of structural spacers twist around the axis of the heater cable in a spiral configuration.

14. The heater cable of claim 11, wherein the plurality of structural spacers each have curved surfaces that cooperate to provide the structural spacer with an impeller cross-sectional shape.

15. The heater cable of claim 10, wherein the plurality of structural spacers each extend around a circumference of the heater cable and are uniformly spaced axially along at least part of the heater cable.

16. The heater cable of claim 10, wherein the plurality of structural spacers have a height that causes partial discharge between the heat tube and the heater cable to be concentrated at points of contact between the plurality of structural spacers and the inner surface of the heat tube.

17. A method of producing a skin effect heating system, the method comprising:
determining, based on at least a heat tube to be coupled to a carrier pipe to deliver heat to the carrier pipe via skin effect heating, a first thickness and a second thickness for an insulation material; and
forming an electrically insulating layer over a core conductor to produce the heater cable, the insulating layer comprising a core insulation having the first thickness and a plurality of structural spacers extending from the core insulation and having the second thickness, such that one or more of the plurality of structural spacers contacts an inner surface of the heat tube and spaces the core insulation away from the inner surface of the heat tube a distance that substantially eliminates partial discharge at an outer surface of the core insulation when alternating current is applied to the core conductor at a voltage exceeding 5 kV.

18. The method of claim 17, wherein forming the electrically insulating layer comprises extruding the core insulation and the plurality of structural spacers together over the core conductor.

19. The method of claim 18, wherein forming the electrically insulating layer comprises forming the plurality of structural spacers as parallel ribs having uniform size and shape, uniformly spaced radially around the core insulation, and extending an entire length of the heater cable.

20. The method of claim 17, wherein forming the electrically insulating layer comprises forming the core insulation from a first insulating material and forming the plurality of structural spacers onto part of an outer surface of the core insulation, the plurality of structural spacers comprising at least a second insulating material different from the first insulating material.
